(19) United States
(12) Patent Application Publication
(10) Pub. No.: US 2007/0091351 A1
(43) Pub. Date: Apr. 26, 2007

(54) Image processing apparatus

(75) Inventors: Yuji Okamoto, Kyoto (JP); Naofumi Ueda, Kyoto (JP); Syoichiro Yoshiura, Nara (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/512,612

(22) Filed: Aug. 29, 2006

(30) Foreign Application Priority Data
Oct. 24, 2005 (JP) 2005-308212

(51) Int. Cl. G06K 15/00

(52) U.S. Cl. 358/1.14; 358/448

(57) ABSTRACT

Input images are efficiently judged to speed up image processing. A document with images recorded on both sides is automatically fed, and the images on the front side and the backside are individually read. Image data for each side is stored in memory. Two judgment sections judge whether the images on the front side and the backside are a specific image, respectively. If the image on either side is judged to be the specific image, copying is inhibited. The reading of the document is stopped, and subsequent copy operations are canceled.

### BACKGROUND OF THE INVENTION

The present invention relates to an image processing apparatus for performing image processing such as recording of an input image on a recording material.

An image processing apparatus reads an image of a document with a scanner, records the image on a recording material, and outputs the image. For documents such as sensitive documents and paper currency, a function to prevent unauthorized copying is provided. That is, it is determined whether an image of a read document contains a specific image, such as a specific pattern or a background tint pattern. If the specific image is recognized, the image recording is inhibited. For example, such image processing based on a specific image is described in Japanese Patent Laid-Open No. 2002-49985 and Japanese Patent Laid-Open No. 2005-231145.

### BRIEF SUMMARY OF THE INVENTION

In recent years, efforts have been made to speed up image processing in the image processing apparatus. Therefore, while images of a sequence of documents are read, the images are recorded on recording materials and are output. In this manner, input and output of images must be done simultaneously to achieve the speedup.

The above-mentioned prevention of unauthorized copying using the specific image requires judgment on an input image. However, this judgment takes time and hampers the speedup. It may be contemplated to reduce the resolution at the time of reading for quick judgment, but this will lower the quality of the image to be recorded. The incompatibility between the speedup of image processing and the improvement in the image quality prevents realization of a high-performance image processing apparatus.

In the light of the above issues, the present invention aims to provide an image processing apparatus that allows efficient image judgment to speed up image processing.

The present invention comprises: image input means that inputs an image; a plurality of judgment means, each judgment means judging whether the input image is a specific image; and control means that performs specific processing if one of the judgment means judges the input image to be the specific image.

The input image is comprised of a plurality of images. The judgment means judge each image individually. This allows a number of images to be judged simultaneously, and therefore the specific image can be quickly found to perform required processing even when many images are input for processing.

The present invention further comprises: a plurality of image input means, each image input means inputting an image; judgment means that judges whether the input image from each image input means is a specific image; and control means that performs specific processing if the judgment means judges the input image to be the specific image.

A plurality of images are input by the image input means. Correspondingly, the judgment means judges each image individually. This also allows a number of images to be judged simultaneously, and therefore a number of input images can be quickly addressed.

If the input images are those on an original document, the document may have the images recorded on both sides, or the document may have the images for a plurality of pages recorded on one side. Therefore, the judgment means comprises a first judgment section that judges an image on a first side of a document and a second judgment section that judges an image on a second side of the document.

That is, for a two-sided document, the first side may be the front side of the document and the second side may be the backside of the document, for example. The judgment sections simultaneously judge the images on both sides of the document. For a document on which images for two pages are recorded on one side, the one side may be divided into two areas, so that one area may be the first side and the other area may be the second side. The judgment sections simultaneously judge the images for two pages. Providing as many judgment units as the number of pages recorded on one side allows the images for these pages to be judged individually.

The image input means comprises a first image input section that reads the image on the first side of the document and a second image input section that reads the image on the second side of the document. For a document with images recorded on both sides, the first image input section reads one side and the second image input section reads the other side. This allows the images on both sides of the document to be read simultaneously. The two judgment sections judge the images on both sides respectively.

As the specific processing, the control means inhibits processing on the input image if the image on one of the first and second sides of the document is judged to be the specific image. As a result, copying of the image or transmission of the image to the outside is canceled, and therefore unauthorized output of images containing sensitive information is prevented.

The control means cancels subsequent image input if the input image is judged to be the specific image. This eliminates unnecessary operation, thereby allowing proceeding to process the next image input.

According to the present invention, a plurality of images can be simultaneously judged for a specific image in a quick manner even when many images are input. Therefore, operations based on the judgment do not hamper the speedup of image processing, and in addition, there is no need to reduce the resolution at the time of reading. Thus, a high-performance image processing apparatus realizing both the speedup and the improved image quality can be provided.

### BRIEF DESCRIPTION OF THE DRAWINGS

FIG. 1 is a diagram showing the schematic configuration of a digital multifunctional machine, which is an embodiment of an image processing apparatus of the present invention;

FIG. 2 is a control block diagram of the multifunctional machine;

FIG. 3 is a diagram showing a document having images recorded on both sides thereof, viewed from below at a reading position;

FIG. 4(a) is a diagram showing documents with images recorded on both sides thereof, and

FIG. 4(b) is a diagram showing the images on the front side and the backside of the documents; and

FIG. 5 is a flowchart for judging whether an image of a document is a specific image.

### DETAILED DESCRIPTION OF THE INVENTION

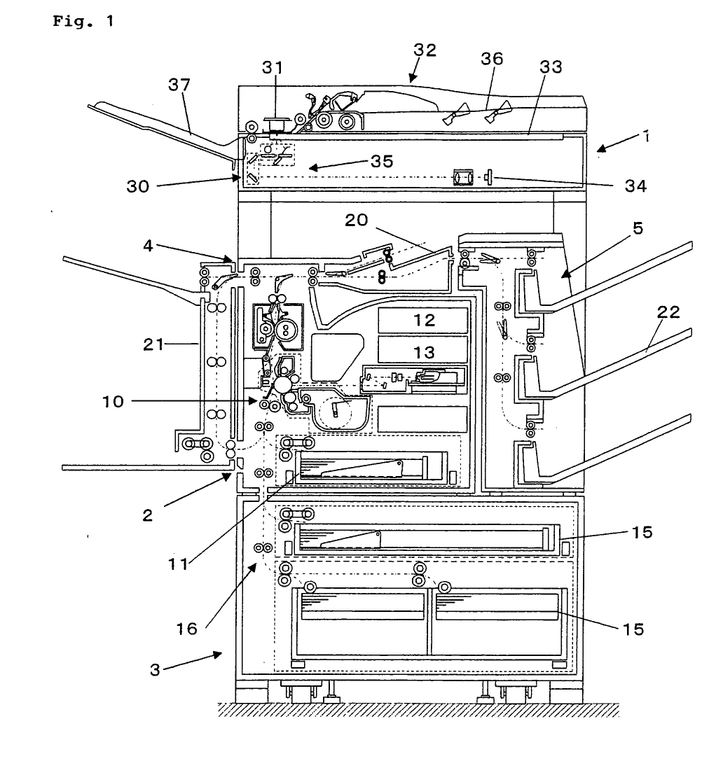

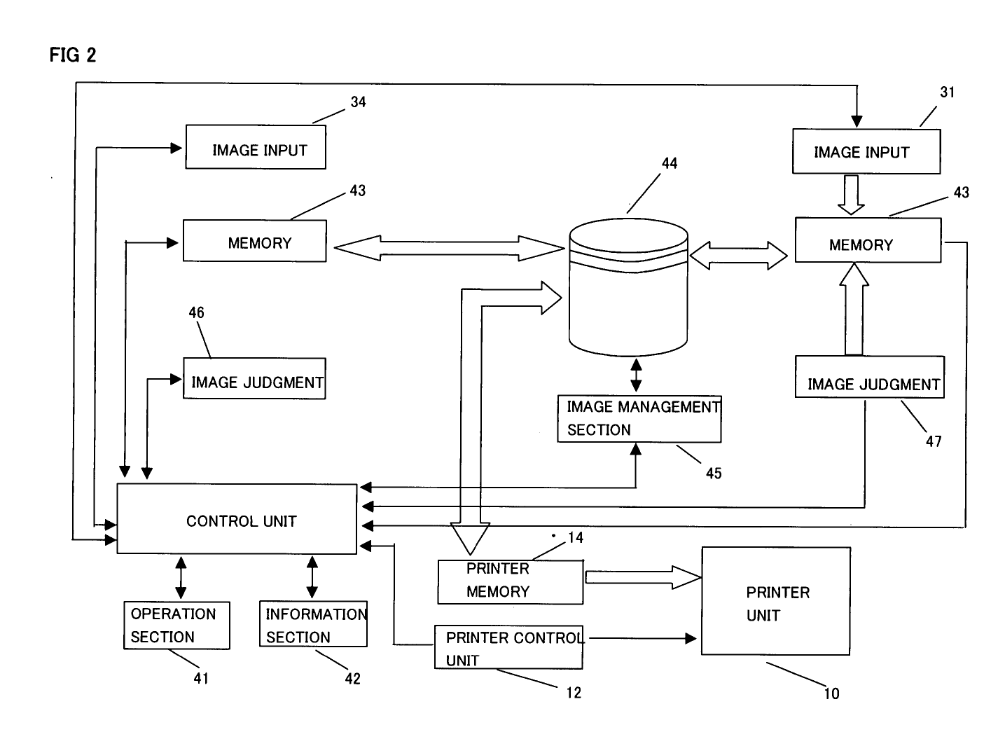

FIGS. 1 and 2 show a digital multifunctional machine, which is an image processing apparatus according to an embodiment of the present invention. The multifunctional machine has copy, printer, scan, and facsimile functions and includes an image reading device 1, an image recording device 2, a multistage paper feeding device 3, a paper ejection processing device 4, and a post-processing device 5. The multifunctional machine is further connected to a telephone line to be able to communicate with facsimile machines, and connected to a network such as a LAN to be able to communicate with external devices such as personal computers and facsimile machines.

The image recording device 2 includes: a printer section 10 for recording an image on paper; a paper storage tray 11 from which paper is fed; a printer control section 12; an image processing section 13; and a printer memory 14. The printer section 10 is an electrophotographic unit comprised of a photoreceptor, an electrifier, an optical scanner, a developing device, a transferring device, a cleaner, a destaticizer, and a fixing device.

The printer control section 12 includes a CPU, ROM, RAM, and so on. In image recording, the printer control section 12 controls the driving of relevant devices according to specified operational conditions. The image processing section 13 uses an image processing LSI to perform certain image processing on input image data, such as correction, compression, decompression, and modification. The printer memory 14 is implemented using semiconductor memory, in which image data subjected to image processing is stored. Thus, the image recording device 2 performs image processing on an image of a document that has been read by the image reading device 1, and records the image on paper and outputs it. The image recording device 2 also performs image processing on image data that has been input from an external apparatus such as a personal computer or a facsimile machine, and records the image on paper and outputs it.

The multistage paper feeding device 3 includes a plurality of paper storage trays 15. In image recording, any one of the paper storage trays 15 is selected and paper is taken from the selected paper storage tray 15. The paper is conveyed by a paper conveyance section 16 comprised of rollers, and fed to the printer section 10.

The paper ejection processing device 4 conveys the paper ejected from the printer unit 10 to a paper ejection board 20 or the post-processing device 5. The destination of the paper is switched between the paper ejection board 20 and the post-processing device 5 according to image processing conditions that have been input. If images are to be recorded on both sides of a sheet of paper, the paper ejection processing device 4 stops conveying the sheet, causes the sheet to be reversed through a reverse conveyance path 21, and conveys the sheet to the printer unit 10.

The post-processing device 5 performs post-processing on recording paper and ejects the recording paper subjected to the post-processing onto any one of a plurality of ejection trays 22. The post-processing may be stapling processing, punching processing, binding processing, and so forth.

The image reading device 1 includes a CCD reading unit 30, a contact image sensor (CIS) 31, and an automatic document conveyer 32. The CCD reading unit 30 is placed under a glass document platform 33, and the automatic document conveyer 32 is openably and closably provided over the document platform 33. The CCD reading unit 30 is comprised of a CCD 34 and an optical unit 35 including lenses and mirrors. The contact image sensor 31 is comprised of a light source, a lens for collecting the reflected light from a document, and a CCD for receiving the reflected light through the lens. The automatic document conveyer 32 conveys a document placed on a document tray 36 toward the document platform 33 and ejects the document onto a document ejection tray 37. A document is placed face up on the document platform 33.

In the CCD reading unit 30, the optical unit 35 moves across a document placed on the document platform 33 to scan the document, and the CCD 34 reads an image of the document. Also, for sheets of documents automatically conveyed by the automatic document conveyer 32, the CCD reading unit 30 reads the documents one by one.

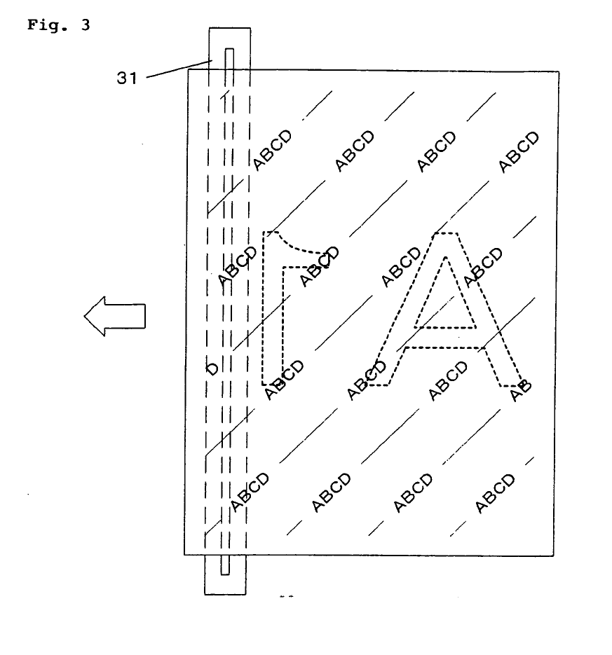

In the latter case, the optical unit 35 is fixed at a reading position, facing the backside of a document being conveyed. The contact image sensor 31 is opposed to the optical unit 35 across the document platform 30 at the reading position, facing the front side of the document being conveyed. Therefore, as shown in FIG. 3, the CCD reading unit 30 reads an image on the backside of the document. The contact image sensor 31 reads an image on the front side of the document. In this manner, the images on both sides of the document being conveyed are simultaneously read.

Besides copy mode in which an image of a document scanned as above is recorded on recording paper, the multifunctional machine implements printer mode, facsimile mode, and scan mode. To implement these modes, as shown in FIG. 2, the multifunctional machine includes: a control section 40 that controls the entire machine; an operation section 41 for a user to perform input operations; an information section 42 that displays operational details, setting information, and so forth; memory sections 43 that store input image data; a hard disk device 44 that temporarily saves image data; an image management section 45 that stores general control information, setting information, and so forth; and a communication section (not shown) that communicates with external apparatus.

Here, the image reading device 1 and the communication section are considered as image input means for inputting images. In response to an input of image data from the image input means, the control section 40 processes the input image data by controlling the control section of each device, such as the printer control section 12, based on the information stored in the image management section 45. That is, the input image data is processed by implementing any one of copy mode, printer mode, scanner mode, and facsimile mode according to an input from the operation section 41 or an instruction from an external apparatus. When an image is recorded in copy mode, printer mode, or facsimile mode, the control section 40 performs image processing on the input image, such as compression, decompression, or modification, according to preset operational conditions. The image from the image data subjected to the image processing is recorded on paper and is output.

The multifunctional machine further has a function to inhibit unauthorized image recording. That is, the multifunction machine includes judgment sections 46 and 47 that judge whether an input image is a specific image. If the judgment sections 46 or 47 judge an image to be a specific image, the control unit 40 performs specific processing, i.e., inhibits processing on the input image. For example, the judgment sections 46 and 47 may be pattern matching circuits, which judge whether or not an input image is a specific image by performing pattern matching between the input image and the specific image.

The image reading apparatus 1 includes two image input sections, i.e., the CCD 34 and the contact image sensor 31. As shown in FIG. 2, a first and second judgment sections, i.e., the judgment sections 46 and 47 are provided for the respective image inputs to simultaneously judge the front side and the backside of a document.

The image data of the document that is input from the image input sections is deployed in the memory 43 and stored therein. The memory 43 stores the image data of the document on a page basis in predetermined storage areas. The first judgment section 46 reads the image data from a storage area for front side pages and performs pattern matching with image data of a particular image. Similarly, the second judgment section 47 reads the image data from a storage area for backside pages and performs pattern matching with the image data of the particular image. The image data of the particular image is input and set in advance, and stored in nonvolatile memory.

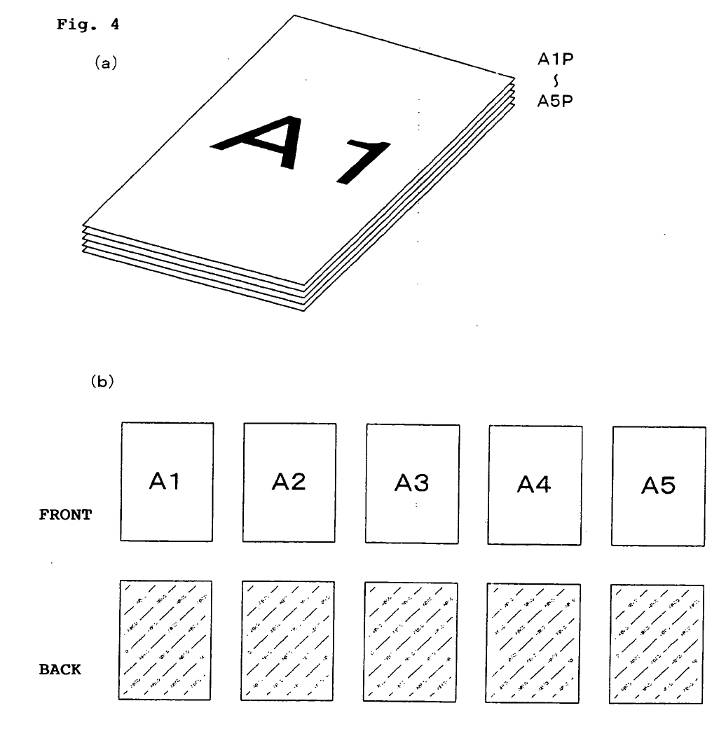

As shown in FIG. 4, regular images are recorded on the front side of a plurality of documents, and a specific image is recorded on the backside of the documents. For example, the specific image may be an image in which a specific pattern is repeated, or a background tint pattern. It is noted that the specific image is not limited to a visible image. Rather, it may be a light-colored image that is hard to recognize visually but can be read by the image reading device 1.

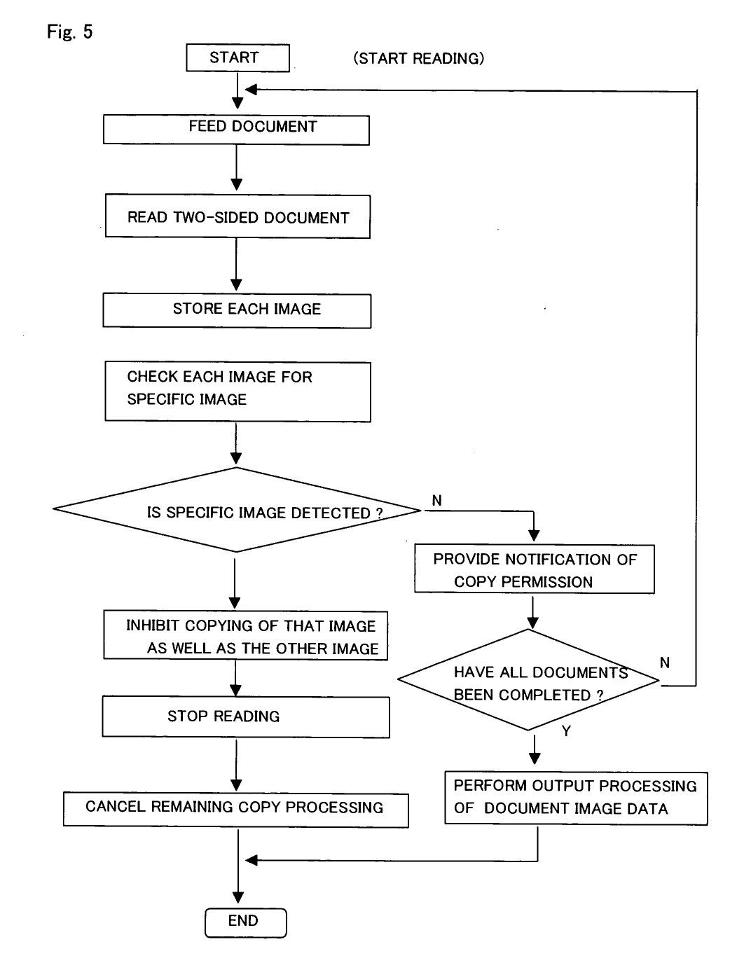

Now, operations in copying documents will be described with reference to FIG. 5. Documents are placed face up at the automatic document conveyer 32. A press of a start button causes the documents to be fed automatically one by one. The CCD 34 reads an image on the backside of a document, and the contact image sensor 31 reads an image on the front side of the document. The read images are stored in the predetermined storage areas in the memory 43 respectively. The first judgment section 46 judges the image on the front side, and the second judgment section 47 judges the image on the backside. These judgments are made simultaneously.

In the present case, a specific image is recorded on the backside. Therefore, the second judgment section 47 judges the image to be the specific image. Then, the control section 40 controls relevant devices to inhibit the copying of the document. That is, the automatic document conveyer 32 is stopped to interrupt the input of images. The operation of the printer section 10 is also stopped. The image data stored in the memory 43 and the hard disk device 44 is erased. Then, the information section 42 provides a display informing about the inability to copy.

If the specific image is not recorded on the document, neither of the judgment sections 46 and 47 detects the specific image. The control section 40 outputs a notification of copy permission to the printer control section 12. This notification is output for each reading of a document. If any of the judgment sections 46 and 47 detects the specific image, processing to inhibit copying is performed. When the reading and judgment of all documents is completed without detection of the specific image, the input images are subjected to image processing, recorded on paper, and output.

In this manner, since images on both sides of a document can be simultaneously judged for the specific image, the judgment can be quickly made even when many documents are read for outputting. This speeds up the image processing apparatus while ensuring to achieve the function of inhibiting unauthorized image recording.

While the above description has been made for the case of implementing copy mode, the quick judgment for a specific image and the fast processing are possible in printer mode or scan mode as well. In printer mode, image data is input from an external apparatus via a network. The input image data is stored in the memory 43. Since the image data is stored on a page basis in separate storage areas, the first and second judgment sections 46 and 47 sequentially judges the image data in the respective storage areas. Thus, the image data stored in the two recording areas is simultaneously judged as to whether it is a specific image. If the image data is judged to be the specific image, the operation of the printer section 10 is stopped and the output of the image is inhibited. This prevents outputting sensitive information.

Similarly in scan mode, the simultaneous judgment is possible because image data read by the image reading device 1 is stored in the respective storage areas in the memory 43. If the image data is judged to be a specific image, the image input is stopped and the storage of input image data is also stopped. Then, stored image data is erased. As a result, processing such as transmitting image data to an external apparatus is canceled, which prevents outputting sensitive information.

Besides those documents with images recorded on both sides as described above, there are documents with images recorded only on one side. On that one side, a specific image may be recorded along with a regular image. When such one-sided documents are conveyed by the automatic document conveyer 32, the images thereon are read by the CCD 34 or the contact image sensor 31. Alternatively, image data of the one-sided documents is input via a network. The input image data is stored on a page basis in the storage areas in the memory 43. Then, the first judgment section 46 judges the image data for odd pages, and the second judgment section 47 judges the image data for even pages. This also allows simultaneous judgment on the images for two pages, and therefore processing of many documents can be addressed.

Instead of storing the input image data on a page basis in the memory 43, one page may be divided into two parts, so that image data for the former part and the latter part may be stored in the respective storage areas in the memory 43. The first judgment section 46 judges the image data of the former part. The second judgment unit 47 judges the image data of the latter part. This increases the speed of judging images per page, and therefore processing of many documents can be addressed.

It is to be understood that the present invention is not limited to the above-described embodiments, but many modifications and alterations may be made to the embodiments within the scope of the present invention. Although the image processing apparatus is a multifunctional machine in the above-described embodiment, it may be an image processing apparatus with a single function, such as a copier or a printer. Furthermore, the printer section is not limited to an electrophotographic printer section but may be an ink-jet printer section.

There may be more than two judgment sections. In that case, image data stored in more than two areas in the memory maybe simultaneously judged, which leads to a quicker judgment. Instead of inhibiting the processing after the judgment, the specific processing may include continuing the processing while recording a blacked-out image or recording a specific character pattern.

What is claimed is:

1. An image processing apparatus comprising:
image input means that inputs an image;
a plurality of judgment means, each judgment means judging whether the input image is a specific image; and
control means that performs specific processing if one of the judgment means judges the input image to be the specific image.

2. An image processing apparatus comprising:
a plurality of image input means, each image input means inputting an image;
judgment means that judges whether the input image from each image input means is a specific image; and
control means that performs specific processing if the judgment means judges the input image to be the specific image.

3. The image processing apparatus according to claim 1 or 2, wherein the judgment means comprises a first judgment section that judges an image on a first side of a document and a second judgment section that judges an image on a second side of the document.

4. The image processing apparatus according to claim 3, wherein the image input means comprises a first image input section that reads the image on the first side of the document and a second image input section that reads the image on the second side of the document.

5. The image processing apparatus according to claim 3, wherein as the specific processing, the control means inhibits processing on the input image if the image on one of the first and second sides of the document is judged to be the specific image.

6. The image processing apparatus according to claim 5, wherein the control means cancels subsequent image input if the input image is judged to be the specific image.
